(19) United States
(12) Patent Application Publication
(10) Pub. No.: US 2023/0253866 A1
(43) Pub. Date: Aug. 10, 2023

(54) HIGH-FREQUENCY HIGH-SPEED SWING MOTOR AND METHOD FOR IMPLEMENTING SAME

(71) Applicant: ZHEJIANG DONGYANG DONGCI CHENGJI ELECTRONICS CO., LTD., Dongyang Jinhua, Zhejiang (CN)

(72) Inventors: Haojing HUANG, Dongyang (CN); Guoyun ZHANG, Dongyang (CN)

(73) Assignee: ZHEJIANG DONGYANG DONGCI CHENGJI ELECTRONICS CO. , LTD., Dongyang Jinhua, Zhejiang (CN)

(21) Appl. No.: 18/003,321

(22) PCT Filed: Jun. 14, 2021
(86) PCT No.: PCT/CN2021/099923

§ 371 Date: Dec. 26, 2022

(30) Foreign Application Priority Data
Aug. 18, 2020 (CN) 202010831400.2

(51) Int. Cl. H02K 33/16

(52) U.S. Cl. CPC H02K 33/16; A61C 17/34

(57) ABSTRACT

A high-frequency high-speed swing motor and a method for implementing same. The motor comprises a housing (9); an end cover (1) is embedded at one end of the housing; a stator assembly is connected to the inner wall of the housing; a rotor assembly is provided inside the stator assembly; the stator assembly comprises coils (5), an iron core (10), and a stator magnetic steel assembly; the iron core is embedded inside the housing; the stator magnetic steel assembly is disposed inside the iron core; the coils are also wound inside the iron core; the rotor assembly comprises an output shaft (8) and a rotor magnetic steel assembly; the two ends of the output shaft are respectively rotatably connected to the housing and the end cover. By means of the interaction between the iron core and rotor magnetic steels (4) and the interaction between stator magnetic steels (6) and the rotor magnetic steels, torques driving the motor to act are generated, and the two torques work in the same mode to jointly increase the no-load frequency of the motor, so as to ensure that the motor has high frequency and high speed even after loading; the motor is obviously better than ordinary brush swing motors and brushless swing motors.

### FIELD OF THE INVENTION

The present invention belongs to the technical field of swing motors, specifically to a high-frequency high-speed swing motor and a method for implementing same.

### BACKGROUND OF THE INVENTION

In recent years, with the continuous expansion of application of motors in consumer electronics, motors are required to be increasingly professional, such as a vibration motor that provides a tactile sense, and a drive motor that provides reciprocating motion. As emerging consumer electronics, electric toothbrushes and facial cleaners can be divided into the following two categories according to different ways to use motors: first, a rotary electric toothbrush, in which, a linear motor provides linear motion which is converted into reciprocating rotation of a brush head by means of mechanical structures such as a connecting rod, a hinge and a wheel disc; and second, an oscillating electric toothbrush, in which, an swing motor provides oscillating motion around a shaft (reciprocating rotation within a certain angle), and a brush head directly sleeves a rotating shaft of the motor, so that the brush head oscillates up and down. The linear motor has the advantages of higher frequency and better cleaning effect, but it has the problems of relatively complex structure and high cost. The swing motor has the advantages of simple application method and low application cost, but its frequency is limited by the structure, so the toothbrush cannot be designed to be higher and the cleaning strength of the toothbrush cannot be compared with that of the former. Therefore, the technical key to improve the competitiveness of a swing motor is to provide a high-frequency high-speed swing motor to enhance the application advantages of such products.

According to the design, swing motors are mainly divided into brush swing motors and brushless swing motors. The structural feature of the brush swing motor is that a coil winding is located on a rotor, and magnetic steel is located on a shell. A coil is powered by an electric brush; and the rotor is pushed to work by means of electromagnetic interaction. The unique structural design of the brush swing motor leads to occupation of a large space by the rotor and a large moment of inertia. Although a no-load frequency is not particularly high, a frequency under a load decreases slightly, but there are unavoidable problems, for example, the electric brush is aged, and a current of the winding cannot be too high (which will affect the life of the electric brush). The structural feature of the brushless swing motor is that an iron core with a coil winding is fixed on a housing, and magnetic steel is located on a rotor. In the unique structural design of the brushless swing motor, a coil is located in a stator portion, so the coil can be directly connected to an external power supply, without an electric brush, and there are no problems such as electric brush aging. At the same time, the life will not be significantly affected even if the current of the coil winding is high. However, due to the small space occupied by the rotor, the moment of inertia is small. Even if the no-load frequency can be equal to that of the brush swing motor, the frequency under a load will decrease significantly. The brushless swing motor is obviously worse than the brush swing motor in application.

### SUMMARY OF THE INVENTION

The present invention aims to provide a high-frequency high-speed swing motor to solve the problems mentioned in the background section. The present invention provides a high-frequency high-speed swing motor which is ensured to also have a high frequency and a high speed after being loaded.

The present invention further aims to provide a method for implementing a high-frequency high-speed swing motor.

In order to achieve the above objectives, the present invention provides the following technical solutions: A high-frequency high-speed swing motor includes a housing; an end cover is embedded in one end of the housing; a stator assembly is connected to an inner wall of the housing; a rotor assembly is provided inside the stator assembly; the stator assembly includes coils, an iron core, and a stator magnetic steel assembly; the iron core is embedded inside the housing; the stator magnetic steel assembly is disposed inside the iron core; the coils are also wound inside the iron core; the rotor assembly includes an output shaft and a rotor magnetic steel assembly; and two ends of the output shaft are rotatably connected to the housing and the end cover, respectively.

Further in the present invention, a bush assembly is embedded inside the iron core; the bush assembly includes two iron core bushes with identical structures; and the coils are wound on Y-shaped protrusions inside the iron core bushes.

Further in the present invention, the stator magnetic steel assembly includes two stator magnetic steels, and the two stator magnetic steels are connected to upper and lower planes inside the iron core bushes, respectively.

Further in the present invention, one end of the output shaft is rotatably connected with the end cover through a first bearing, and the other end of the output shaft is rotatably connected with the housing through a second bearing.

Further in the present invention, a rotor base is inlaid outside the output shaft, and the rotor base is located inside the housing.

Further in the present invention, the rotor magnetic steel assembly includes four rotor magnetic steels, and the four rotor magnetic steels are uniformly embedded on a circumference of the rotor base.

Further in the present invention, the end cover is a plastic component; and the end cover is provided with a wire passing hole for communicating the coils with an external power supply.

Further in the present invention, every two of the four rotor magnetic steels form one group, and the two groups of rotor magnetic steels have opposite magnetization directions.

Further in the present invention, a method for implementing the high-frequency high-speed swing motor includes the following steps:

(I) embedding the two iron core bushes inside the iron core, respectively connecting the two stator magnetic steels to the upper and lower planes inside the iron core bushes, and respectively winding the Y-shaped protrusions inside the iron core bushes by the two groups of coils, thus forming the stator assembly;

(II) inlaying the rotor base outside the output shaft, and uniformly embedding the four rotor magnetic steels on the circumference of the rotor base, thus forming the rotor assembly;

(III) providing, by the two stator magnetic steels and the four rotor magnetic steels, a magnetic field for the rotor assembly; and

(IV) making power to the coils to generate an electromagnetic field that interacts with the magnetic field to drive the rotor assembly to rotate in a reciprocating manner.

Further in the present invention, the end cover is a plastic component; the end cover is provided with a wire passing hole for communicating the coils with an external power supply; every two of the four rotor magnetic steels form one group, and the two groups of rotor magnetic steels have opposite magnetization directions; two rotor magnetic steels with opposite magnetic poles face the positions of the Y-shaped protrusions of the iron core; and two rotor magnetic steels with the same magnetic poles face positions where the stator magnetic steels are located.

Compared with the prior art, the present invention has the following beneficial effects.

1. By means of the interaction between the iron core and rotor magnetic steels and the interaction between stator magnetic steels and the rotor magnetic steels, torques driving the motor to act are generated. The two torques work in the same mode to jointly increase the no-load frequency of the motor, so as to ensure that the motor has a high frequency and a high speed even after being loaded; and the motor is obviously better than an ordinary brush swing motor and a brushless swing motor.

2. When the coils are powered off, the torque on the rotor assembly always points to an equilibrium position. The rotor magnetic steels move relative to the stator assembly, so that the magnetic flux on the iron core continuously changes, causing an induced electromotive force inside the coils, and resulting in that the kinetic energy is quickly converted into heat energy for dissipation and the motor stops quickly.

3. The rotor base of the present invention is a magnetically conductive material, such as stainless iron and silicon steel. An upper cavity of the rotor base provides an assembling surface for assembling the rotor magnetic steels and gathers the magnetic field of the motor to increase the torque of the motor.

4. The iron core of the present invention is a magnetically conductive material, which not only provides a fixing and accommodating space for other components of the stator, but also gathers a working magnetic field to increase the utilization rate of the magnetic field and reduce leakage flux.

### BRIEF DESCRIPTION OF THE DRAWINGS

FIG. 1 is an exploded structural diagram of the present invention;

FIG. 2 and FIG. 3 are schematic diagrams of an axial sectional structure of the present invention;

FIG. 4 is a schematic diagram of a radial sectional structure of the present invention; and

FIG. 5 is a schematic diagram of a coil current phase relationship of the present invention, the arrow direction being a magnetization direction.

In the drawings: 1: end cover; 2: first bearing; 3: iron core bush; 4: rotor magnetic steel; 5: coil; 6: stator magnetic steel; 7: second bearing; 8: output shaft; 9: housing; 10: iron core; and 11: rotor base.

### DETAILED DESCRIPTION OF THE EMBODIMENTS

The technical solutions in the embodiments of the present invention will be described clearly and completely below in combination with the accompanying drawings of the embodiments of the present invention. Apparently, the described embodiments are only part of the embodiments of the present invention, not all embodiments. All other embodiments obtained by those of ordinary skill in the art based on the embodiments in the present invention without creative work shall fall within the protection scope of the present invention.

### Embodiment 1

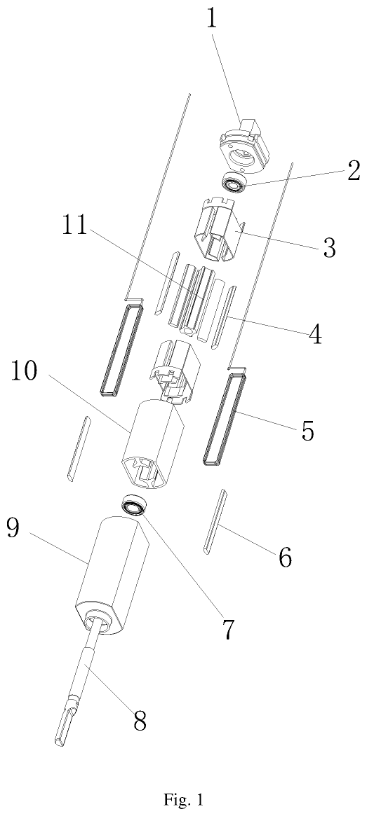

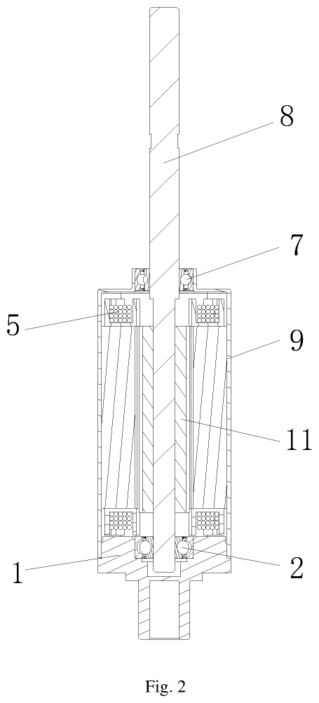

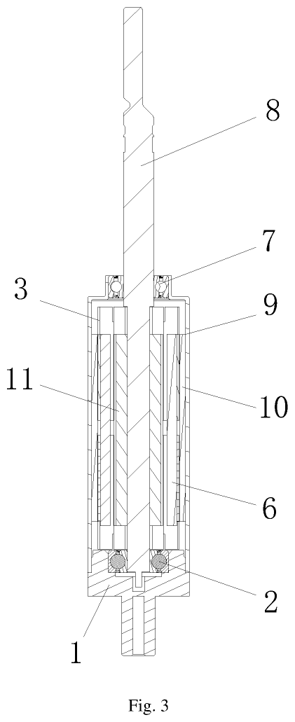

Referring to FIG. 1 to FIG. 5, the present invention provides the following technical solutions: A high-frequency high-speed swing motor includes a housing 9; an end cover 1 is embedded in one end of the housing 9; a stator assembly is connected to an inner wall of the housing 9; a rotor assembly is provided inside the stator assembly; the stator assembly includes coils 5, an iron core 10, and a stator magnetic steel assembly; the iron core 10 is embedded inside the housing 9; the stator magnetic steel assembly is disposed inside the iron core 10; the coils 5 are also wound inside the iron core 10; the rotor assembly includes an output shaft 8 and a rotor magnetic steel assembly; and two ends of the output shaft 8 are rotatably connected to the housing 9 and the end cover 1, respectively.

Further, a bush assembly is embedded inside the iron core 10; the bush assembly includes two iron core bushes 3 with identical structures; and the coils 5 are wound on Y-shaped protrusions inside the iron core bushes 3.

By means of the above technical solution, the iron core 10 is a magnetically conductive material, such as stainless iron and silicon steel. In this embodiment, the silicon steel material is preferred, which not only provides a fixing and accommodating space for other components of the stator, but also gathers a working magnetic field to increase the utilization rate of the magnetic field and reduce leakage flux. At an equilibrium position, forces on the iron core 10 and the rotor magnetic steels 4 are balanced, so that the rotor assembly is kept at the equilibrium position. Once the rotor assembly rotates a certain angle, the attractive force of the iron core 10 may cause the rotor assembly to generate a torque opposite to a rotating direction and pointing to the equilibrium position. The iron core bushes 3 are made of an insulating material which is plastic in this embodiment, mainly provide a supporting surface for the winding of the coils 5 and provide a space for winding the coils 5.

Further, the stator magnetic steel assembly includes two stator magnetic steels 6, and the two stator magnetic steels 6 are connected to upper and lower planes inside the iron core bushes 3, respectively.

By means of the above technical solution, the stator magnetic steels 6 are opposite to the rotor magnetic steels 4 in the same poles. At the equilibrium position, forces on the stator magnetic steels 6 and the rotor magnetic steel 4 are balanced, and the rotor assembly is stationary at the equilibrium position. Once the rotor assembly rotates at a certain angle, the repulsive force of the stator magnetic steel 6 against the rotor magnetic steel 4 with the same pole close to the stator magnetic steel increases, and the repulsive force against the rotor magnetic steel 4 with the same pole far away from the stator magnetic steel decreases, so that the force balance is destroyed. The direction of the torque on the rotor assembly is opposite to the rotating direction and points to an initial equilibrium position.

The torque working mode between the stator magnetic steels 6 and the rotor magnetic steels 4 is the same as that between the iron core 10 and the rotor magnetic steels 4 to jointly improve the no-load frequency of the motor and ensure that the motor also has high frequency and high speed after being loaded.

Further, one end of the output shaft 8 is rotatably connected with the end cover 1 through a first bearing 2, and the other end of the output shaft 8 is rotatably connected with the housing 9 through a second bearing 7.

By means of the above technical solution, the output shaft 8 is stainless steel that lacks magnetic conductivity. The output shaft fixes a bearing inner race and a rotor base 11, and outputs the motion of the rotor of the motor. The rotor assembly can rotate by means of the arrangement of the first bearing 2 and the second bearing 7.

Further, the rotor base 11 is inlaid outside the output shaft 8, and the rotor base 11 is located inside the housing 9.

By means of the above technical solution, the rotor base 11 is a magnetically conductive material, such as stainless iron and silicon steel. The silicon steel material is preferred in this embodiment. An upper cavity of the rotor base provides an assembling surface for assembling the rotor magnetic steels 4 and gathers the magnetic field of the motor to increase the torque of the motor.

Further, the rotor magnetic steel assembly includes four rotor magnetic steels 4, and the four rotor magnetic steels 4 are uniformly embedded on a circumference of the rotor base 11. Every two of the four rotor magnetic steels 4 form one group, and the two groups of rotor magnetic steels 4 have opposite magnetization directions. Two rotor magnetic steels 4 with opposite magnetic poles face the positions of the Y-shaped protrusions of the iron core 10; and two rotor magnetic steels 4 with the same magnetic poles face positions where the stator magnetic steels 6 are located.

### Embodiment 2

A difference between this embodiment and Embodiment 1 lies in: Further, the end cover 1 is a plastic component; and the end cover 1 is provided with a wire passing hole for communicating the coils 5 with an external power supply.

By means of the above technical solution, a passage is provided for communicating the coils 5 with the external power supply, and main portions of the motor are closed inside the housing 9.

Further, a method for implementing the high-frequency high-speed swing motor of the present invention includes the following steps:

(I) the two iron core bushes 3 are embedded inside the iron core 10; the two stator magnetic steels 6 are connected to the upper and lower planes inside the iron core bushes 3, respectively; and the two groups of coils 5 are respectively wound on the Y-shaped protrusions inside the iron core bushes 3, thus forming the stator assembly;

(II) the rotor base 11 is inlaid outside the output shaft 8, and the four rotor magnetic steels 4 are uniformly embedded on the circumference of the rotor base 11, thus forming the rotor assembly;

(III) the two stator magnetic steels 6 and the four rotor magnetic steels 4 provide a magnetic field for the rotor assembly; and

(IV) power is made to the coils 5 to generate an electromagnetic field that interacts with the magnetic field to drive the rotor assembly to rotate in a reciprocating manner.

The working principle of the present invention is as follows:

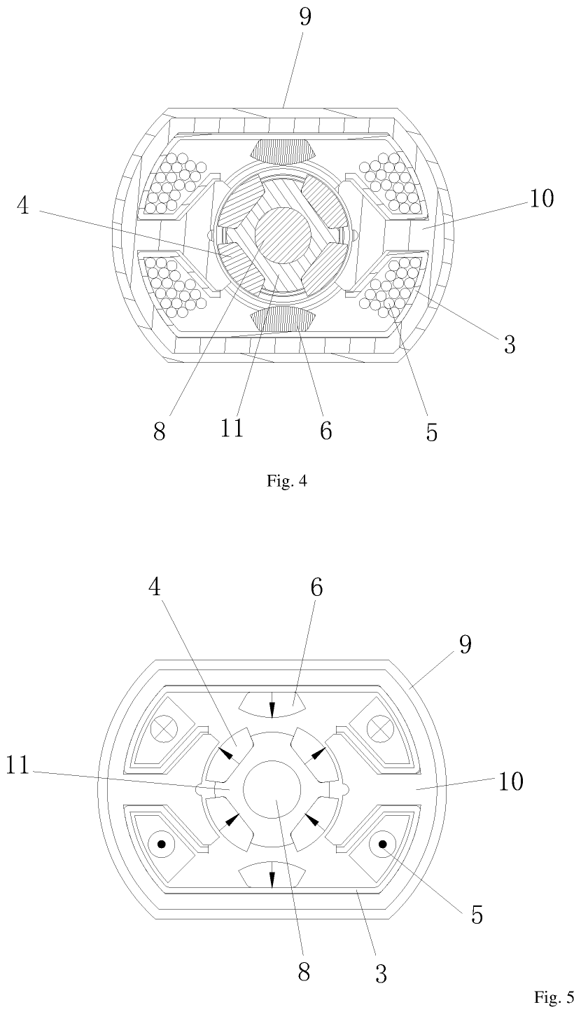

(I) When no power is made to the coils, the rotor assembly is located at the position as shown in FIG. 5. At this time, the forces on the rotor assembly are balanced, so that the position is an initial equilibrium position of the motor.

(II) When power is made to the coils 5, a magnetic field is generated in the iron core 10 to push the rotor magnetic steels 4 to generate torques, so that the rotor assembly rotates to leave the equilibrium position.

(III) When the coils 5 are powered off, the torque on the rotor assembly always points to the equilibrium position. The rotor magnetic steels 4 move relative to the stator assembly, so that the magnetic flux on the iron core 10 continuously changes, causing an induced electromotive force inside the coils 5, and resulting in that the kinetic energy is quickly converted into heat energy for dissipation and the motor stops quickly.

(IV) At the equilibrium position, forces on the iron core 10 and the rotor magnetic steels 4 are balanced, so that the rotor assembly is kept at the equilibrium position. Once the rotor assembly rotates a certain angle, the attractive force of the iron core 10 may cause the rotor assembly to generate a torque opposite to a rotating direction and pointing to the equilibrium position.

(V) At the equilibrium position, forces on the stator magnetic steels 6 and the rotor magnetic steel 4 are balanced, and the rotor assembly is stationary at the equilibrium position. Once the rotor assembly rotates at a certain angle, the repulsive force of the stator magnetic steel 6 against the rotor magnetic steel 4 with the same pole close to the stator magnetic steel increases, and the repulsive force against the rotor magnetic steel 4 with the same pole far away from the stator magnetic steel decreases, so that the force balance is destroyed. The direction of the torque on the rotor assembly is opposite to the rotating direction and points to the initial equilibrium position.

(VI) The above two torque working modes are the same, which jointly improves the no-load frequency of the motor and ensure that the motor also has a high frequency and a high speed after being loaded. The motor is significantly better than an ordinary brush swing motor and brushless swing motor.

Although the embodiments of the present invention have been shown and described, it will be understood by those of ordinary skill in the art that various changes, modifications, substitutions, and variations can be made to these embodiments without departing from the principle and spirit of the present invention. The scope of the present invention is defined by the attached claims and their equivalents.

1. A high-frequency high-speed swing motor, comprising a housing (9), wherein an end cover (1) is embedded in one end of the housing (9); a stator assembly is connected to an inner wall of the housing (9); a rotor assembly is provided inside the stator assembly; the stator assembly comprises coils (5), an iron core (10), and a stator magnetic steel assembly; the iron core (10) is embedded inside the housing (9); the stator magnetic steel assembly is disposed inside the iron core (10); the coils (5) are also wound inside the iron core (10); the rotor assembly comprises an output shaft (8) and a rotor magnetic steel assembly; and two ends of the output shaft (8) are rotatably connected to the housing (9) and the end cover (1), respectively.

2. The high-frequency high-speed swing motor according to claim 1, wherein a bush assembly is embedded inside the iron core (10); the bush assembly comprises two iron core bushes (3) with identical structures; and the coils (5) are wound on Y-shaped protrusions inside the iron core bushes (3).

3. The high-frequency high-speed swing motor according to claim 2, wherein the stator magnetic steel assembly comprises two stator magnetic steels (6), and the two stator magnetic steels (6) are connected to upper and lower planes inside the iron core bushes (3), respectively.

4. The high-frequency high-speed swing motor according to claim 1, wherein one end of the output shaft (8) is rotatably connected with the end cover (1) through a first bearing (2), and the other end of the output shaft (8) is rotatably connected with the housing (9) through a second bearing (7).

5. The high-frequency high-speed swing motor according to claim 1, wherein a rotor base (11) is inlaid outside the output shaft (8), and the rotor base (11) is located inside the housing (9).

6. The high-frequency high-speed swing motor according to claim 5, wherein the rotor magnetic steel assembly comprises four rotor magnetic steels (4), and the four rotor magnetic steels (4) are uniformly embedded on a circumference of the rotor base (11).

7. The high-frequency high-speed swing motor according to claim 1, wherein the end cover (1) is a plastic component; and the end cover (1) is provided with a wire passing hole for communicating the coils (5) with an external power supply.

8. The high-frequency high-speed swing motor according to claim 1, wherein every two of the four rotor magnetic steels (4) form one group, and the two groups of rotor magnetic steels (4) have opposite magnetization directions.

9. A method for implementing the high-frequency high-speed swing motor according to claim 1, comprising the following steps:
(I) embedding the two iron core bushes (3) inside the iron core (10), connecting the two stator magnetic steels (6) to the upper and lower planes inside the iron core bushes (3), respectively, and winding the Y-shaped protrusions inside the iron core bushes (3) by the two groups of coils (5), thus forming the stator assembly;
(II) inlaying the rotor base (11) outside the output shaft (8), and uniformly embedding the four rotor magnetic steels (4) on the circumference of the rotor base (11), thus forming the rotor assembly;
(III) providing, by the two stator magnetic steels (6) and the four rotor magnetic steels (4), a magnetic field for the rotor assembly; and
(IV) energizing the coils (5) to generate an electromagnetic field that interacts with the magnetic field to drive the rotor assembly to rotate in a reciprocating manner.

10. The method for implementing the high-frequency high-speed swing motor according to claim 9, wherein the end cover (1) is the plastic component; the end cover (1) is provided with the wire passing hole for communicating the coils (5) with an external power supply; every two of the four rotor magnetic steels (4) form one group, and the two groups of rotor magnetic steels (4) have opposite magnetization directions; two rotor magnetic steels (4) with opposite magnetic poles face the positions of the Y-shaped protrusions of the iron core (10); and two rotor magnetic steels (4) with the same magnetic poles face positions where the stator magnetic steels (6) are located.
